(19) United States
(12) Patent Application Publication
(10) Pub. No.: US 2008/0311880 A1
(43) Pub. Date: Dec. 18, 2008

(54) Checkinsafe.com

(75) Inventor: James E. Copley, III, Minneapolis, MN (US)

Correspondence Address: James E. Copley III, 4536 Park Avenue S., Minneapolis, MN, 55407, US

(73) Assignee: Mr. James Earl Copley, Minneapolis, MN (US)

(21) Appl. No.: 12/157,401

(22) Filed: Jun. 10, 2008

Related U.S. Application Data
(60) Provisional application No. 60/934,177, filed on Jun. 12, 2007.

(51) Int. Cl. H04M 11/04

(52) U.S. Cl. 455/404.1

(57) ABSTRACT

An integrated method and system for entry, storage and timed forwarding of user-controlled, event specific, content is described herein. User securely accesses the system through a computing device, enters and stores event information. User's event information is stored in a remote, secure computer server device. User sets a timer within the system that forwards the user's stored information by means of electronic mail (email) or text message (SMS). User established timer can be turned off by user through Internet interface with Internet website to stop message from forwarding. In the event that user does not check in from self-registered event, information stored about said event is forwarded automatically to the users contacts by email or text message or through both methods.

The present invention relates to the field of information storage and forwarding, specifically email and SMS message systems.

### BACKGROUND OF THE INVENTION

With the need for personal safety and security, individuals have sought new ways to integrate technology as a means of assistance. Yet in an emergency situation it can become difficult, even impossible to actively use technology to reach such assistance. An individual may be going about an event and find themselves incapacitated or unable to seek help for any number of reasons. An individual injured in an automobile accident may be unable to move, an individual in an uncomfortable or even threatening social situation may not be able to reach for help and a person with dementia or Alzheimer's may lose their way home or become disoriented while driving and become lost. Any number of maladies may require regular outside supervision to ensure such individual's safety in going about daily events and activities. Accordingly it would be beneficial to the safety of all persons to have a system for entering and storing event information integrated with system of self-established timed alerts forwarding event information to their contacts in the case of a missed check in from said event.

### SUMMARY OF THE INVENTION

Each user establishes an account. User enters into this account their personal contacts, which are stored on remote secure servers. User enters event specific information pertaining to where they are going for said event, what information user would like their contacts to know in case user should fail to check in from said event, what time they will check in and who on the contact list should be sent the event information should user fail to check in from event. Event may be any personal or professional activity, trip engagement, episode, happening, appointment, rendezvous, outing, assignment or date. User event information is stored on a server connected to an internal computing program that monitors all user timers. Should a user miss a check in their timer will send an internal alert which retrieves users event information and forwards said information to users pre-established contacts through email, SMS message or both. Users event information is only forwarded in the case of a missed check in. In the event the user connects into system and checks in from event, prior to system timer being triggered, no message is sent.

### DESCRIPTION OF PREFERRED EMBODIMENT

1 The Checkinsafe.com system is a self-managed online emergency contact system. A user simply logs onto the website and enters the where, what and when of any user event. User chooses who they would like notified should they not check in at their established time. Should user fail to check in on time from a pre-entered event, their personal message will be sent out, via e-mail, text (SMS) message or both to their pre-designated contacts through an Internet connected computer or Internet connected phone/PDA.
2 User privacy is important and so we designed the CheckInSafe.com system to intrude on privacy only when necessary, only in the case that a user does not check in. We only forward the information entered by our users to the contacts they pre-enter. The system allows user to know that in case of any mishap or delay, natural or unnatural, the message they have pre-written will be forwarded to their contacts by either email or text (SMS) message or both.
3 The Checkinsafe.com system works by establishing an individual user profile within our system. Each user's account is monitored for missed check-in alerts on a constant basis by our internal software program and in the event of a missed check-in the system automatically send out the user's personal message by the method established by user which could be an email message, a text (SMS) message or both the contacts the user has pre-established within their account.
4 User information is stored in a database on a grid server system that disallows any interruption in server response times due to heavy traffic or site overload.
5 The Checkinsafe.com system coding is written to account for changes in time zone, daylight savings time and to alert user pro-actively to impending check-in time expiration. The system allows user to check-in from any Internet connected portal be it a personal computer, Internet enabled cell phone or any other Internet connected device.

That which is claimed is:

1. A communications system comprising: at least one Internet enabled personal computing device for entry of users personal event information into server; at least one Internet connected server for storing said users personal event information; at least one internally hosted computing program for timed forwarding of said users personal event information through email; at least one internally hosted computing program for timed forwarding of said users personal event information through text message (SMS); at least one internally hosted computing system for user-controlled cancellation of email forwarding of said users previously stored personal event information; at least one internally hosted computing system for user-controlled cancellation of text message (SMS) forwarding of said users previously stored personal event information; at least one computer software system for remote verification to change event information; at least one computer software system for identification and application of time-zone variations; at least one system for entry and storage of personal contact information; at least one system of integration allowing stored personal event information to be stored in users account.

2. The timed email-forwarding system of claim 1 wherein the system only activates the timed forwarding request in the case of a missed check-in by said user.

3. The timed text message (SMS)-forwarding system of claim 1 wherein the system only activates the timed forwarding request in the case of a missed check-in by said user.

4. The proprietary software program of the timed SMS forwarding system of claim 1 is in communication with an SMS server, allowing user to communicate with said server through Internet enabled personal computing device.

5. The proprietary software program of the timed email forwarding system of claim 1 is in communication with an email server, allowing user to communicate with said server through Internet enabled personal computing device.
